(19) United States
(12) Patent Application Publication
(10) Pub. No.: US 2008/0196012 A1
(43) Pub. Date: Aug. 14, 2008

(54) SYSTEM AND METHODS FOR STATIC ANALYSIS OF LARGE COMPUTER PROGRAMS AND FOR PRESENTING THE RESULTS OF THE ANALYSIS TO A USER OF A COMPUTER PROGRAM

(75) Inventors: Yossi COHEN, Raanana (IL); Nurit DOR, Raanana (IL); Dror WEISS, Netanya (IL); Shay LITVAK, Tel Aviv (IL); Mati COHEN, Raanana (IL); Roy ARMONI, Givat Ada (IL)

Correspondence Address: OLIFF & BERRIDGE, PLC, P.O. BOX 320850, ALEXANDRIA, VA, 22320-4850, US

(73) Assignee: PANAYA LTD., Raanana (IL)

(21) Appl. No.: 11/947,477

(22) Filed: Nov. 29, 2007

Related U.S. Application Data
(60) Provisional application No. 60/900,720, filed on Feb. 12, 2007.
(60) Provisional application No. 60/912,706, filed on Apr. 19, 2007.

(51) Int. Cl. G06F 9/44; G06F 3/048

(52) U.S. Cl. 717/125

(57) ABSTRACT

A system and method for analyzing a computer program comprising a first multiplicity of elements having a second multiplicity of functional relationships defined therebetween, the first multiplicity of elements including interface elements and non-interface elements, the method comprising reading source code, finding at least selected interface elements in the source code, and identifying, and displaying to a user, only those functional relationships which are defined between the selected interface elements.

### REFERENCE TO RELATED APPLICATIONS

This application claims priority from U.S. Provisional Application No. 60912706, filed Apr. 19, 2007 and entitled as above, and from U.S. Provisional Application No. 60900720, filed Feb. 12, 2007 and entitled “Methods for supplying code analysis results by using user language”.

### FIELD OF THE INVENTION

The present invention relates generally to apparatus and methods for analyzing computer programs.

### BACKGROUND OF THE INVENTION

The state-of-the-art in analysis of computer programs is believed to be represented in the following patent documents: U.S. Pat. No. 6,058,265; U.S. Pat. No. 5,161,216; U.S. Pat. No. 5,854,925; U.S. Pat. No. 7,013,457; and U.S. Pat. No. 6,289,264 all pertaining to root cause analysis; US20060168565A1 and US20050166094A1 both pertaining to impact analysis; US20050273777A1; US20050257202A1; US20060085782A1; US20050273777A1 and U.S. Pat. No. 7,089,542, all pertaining to slicing; U.S. Pat. No. 05,673,387 pertaining to regression testing; U.S. Pat. No. 6,314,562 pertaining to anticipatory optimization of computer programs; U.S. Pat. No. 5,797,012 pertaining to use of weights; U.S. Pat. No. 7,013,457 pertaining to use of priorities; US20050262472A1 pertaining to error messages in ERP; US20050125393A1 pertaining to Oracle SQL statements; US20050119999A1 pertaining to Oracle query statements; US20030220941A1 pertaining to optimization of statements in a statement pool; and WO0231657A2 and U.S. Pat. No. 5,297,150 pertaining to generation of program tests.

Methods for analyzing programs are also described in the following publications and documents:

Advanced Compiler Design and Implementation (1st edition) by Steven Muchnick, Morgan Kaufmann 1997, ISBN 1558603204.

Compilers: Principles, Techniques, and Tools (2nd Edition) by Alfred V. Aho Monica S. Lam, Ravi Sethi, Jeffrey D. Ullman.

Principles of Program Analysis, by Flemming Nielson, Hanne R. Nielson, Chris Hankin

“A Survey of Program Slicing Techniques”, Frank Tip, Journal of programming languages, 3(3) 1995, pages 121-189.

“Constant propagation with conditional branches”, Mark N. Wegman and F. Kenneth Zadeck, 1991

“Symbolic path simulation in path-sensitive dataflow analysis”, Hari Hampapuram, Yue Yang, Manuvir Das, PASTE 2005.

The disclosures of all publications mentioned in the specification, and of the publications cited therein directly or indirectly, are hereby incorporated by reference.

### SUMMARY OF THE INVENTION

Certain embodiments of the present invention seek to provide improved apparatus and methods for analyzing computer programs.

Certain embodiments of the present invention seek to provide apparatus and methods for finding functional relationships among statements in a program.

The system of the present invention is preferably operative to present to a user thereof, a change that will result in the functional behavior of a program, also termed herein “the input program”, as a result of at least one customization and/or code change thereto. Alternatively or in addition, the system of the present invention is operative to present to a user thereof, a customization and/or code change to the program which will result in a given functional behavior change. Customization and/or configuration are changes to the behavior of the program that are done by setting the program's parameters.

Functional behavior changes may include one, some or all of the following: output values being used by other programs or by external systems; or which are viewed by an end user such as screen field values or reports; values written to or read from database tables, external files or shared memory; external programs called by the input program, and messages displayed by the input program.

The system of the present invention is also preferably operative to identify the root-cause of a problematic behavior of the input program such as but not limited to an error message displayed by the input program; an output screen field value or portion of a report, generated by the input program which is not to the satisfaction of the input program's user; an abnormal program termination or crash of the input program; a failure of the input program to communicate with some other program; or an instance in which an external program fed by the input program does not run as expected by a user of the external program, presumably due to the data it is receiving from the input program.

The system of the present invention is further preferably operative to identify the impact of an input program user's customization of the input program. The impact may for example comprise changes in screen fields, changes in error message generation (more, less or different messages being generated as a result of the customization).

The system of the present invention is also preferably operative to identify a relationship between a specific code fragment, and the input program's input, output or both.

The system of the present invention is also preferably operative to perform static program investigation.

The following terms used herein encompass the following definitions, respectively, inter alia, or may alternatively encompass definitions known in the art:

An “element” or “program element” is either a statement or a variable in a program under investigation.

A “data element” is a variable, not necessarily a scalar.

“Ranking” refers to classifying the relative centrality of each element in a set of elements returned as a result of a query on a computer program, or specifically to sequencing a set of software system elements, in order of their importance to or functional dependency upon a user of the software system.

An “impacting element” is a statement in a program which, if modified or removed or if values are assigned/changed to the variables that it uses, affects the program's behavior. Impacting elements may be identified by a slicing process or by computation of reachable elements as described herein. Each variable defined by an “impacting statement” is termed herein an “impacting variable”. A data element which is found, e.g. by slicing or by computation of reachable elements, to be an impacting element is also termed herein an “impacting variable”.

A “configuration” of a program is a set of values for some or all of the impacting variables within that program.

An “Impacted element” is any program element that may be affected by one or more impacting elements, such as but not limited to contents of various fields in various screens which may be added, modified, or erased; contents of various records in various databases which may be added, modified or erased, and system-created outputs other than database or screen contents, such as error messages. Impacted elements may be identified by a slicing process or by computation of reachable elements as described herein. Some program elements may be neither impacting nor impacted.

“Interface elements” is a set of elements within a program comprising a union of the impacting elements in the program and the impacted elements in the program.

“Non-interface elements” is a set of all elements within a program which are not interface elements.

The system is preferably operative to detect which variables or statements in the program are impacted, which are impacting and which are neither. This takes place in the course of “slicing”, in Impact Analysis and Root Cause Analysis and by computation of reachable elements, in Program Investigation.

“Static impact analysis” or “impact analysis” refers to identification of functionally dependent behavior of functionally dependent portions of a software system, due to at least one change in the source code of the system, at least one customization change of the system, or at least one change in the system's parametric values.

“Functional relationship” between elements includes either of the following two types of dependency:

(a) The dependency between a “definition” statement s1 that assigns data to a variable v and a “using” statement s2 that uses v. For instance:

s1: v=u+3

s2: w=v+u

(b) The dependency between a statement s3 and s4, where s3 controls whether s4 is executed:

s3: if(condition)

then

s4: select*from tab1 into wa1

More generally, statements s and t in a program are said to have a “functional relationship” defined between them, or are said to “have functional dependency” between them if there is a path between s and t in the following graph:
(a) The graph's set of nodes is the set of all statements in the program, and
(b) The graph's edges include (1) All the edges from the program's def-to-use graph, and (2) for each control flow statement si in the program, an edge from s1 to every statement s2 that is controlled by s1.
   Functional relationship between statements also induces functional relationship between data elements which are not necessarily statements. If s and t are statements between which there is a functional relationship, and s defines a variable v, and t defines a variable u, then a functional relationship exists between v and u, between v and t, and between s and u.

A “query” is a user request to identify all program elements having a given functional relationship with a given set of one or more program elements. For example, a query may request identification of all statements which impact on a given error statement. This type of query is termed “root cause analysis”. A query may also request identification of all statements and variables impacted by a given statement. This type of query is termed “impact analysis”.

An “externally visible statement” is a statement which uses or modifies a characteristic of a program which is discernable by a user of the program, such as an input statement, output statement, statement of assignment to a screen field, database table accessing statement, file accessing statement, and error message generating statement.

“Importance” is a subjective measure of how important a section of computer code is for a user or population of users. For example, code that many processes use may be deemed more important than one that is used by fewer processes. Code pertaining to (generating or maintaining, for example) a balance sheet may be deemed more important than code pertaining to a list of materials, for one population of users, whereas the code pertaining to the list of materials may be deemed more important than that pertaining to the balance sheet, for another population of users.

“Intensity” is an objective characteristic of a statement that measures how intense the statement is in a program. For example, an insert to a database may be deemed more intense than a simple assignment.

“Relevance” of code refers to how often the code is used. For instance, database access to a table that turns out to be empty is probably not relevant.

The ranking method of the present invention preferably ranks elements or components of a software system to determine order of display thereof, such as but not limited to some or all of the following elements or components: statements; code blocks; functions, procedures and other callable blocks; events, screens; programs; programs in context; data elements (variables). Ranking is typically performed as a function of an application-specific combination, such as a weighted combination, of some or all of the following:

a. The intensity of the impacting element's impact upon a user of the system;

b. The centrality of that impact to the system's functionality. For example, impact on a process which produces a balance sheet for an organization may be deemed more important than impact on a less crucial process which merely lists all materials present in the organization. Impact on a program used by 90% of an organization's workforce is more important than the same type of impact on another program used by only 1% of the organization's workforce; and

c. The relevance of that impact. For example, impact on dead code, or on programs never used, may be of zero or near-zero relevance.

There is thus provided, in accordance with certain embodiments of the present invention, a method for analyzing a computer program comprising a first multiplicity of elements having a second multiplicity of functional relationships defined therebetween, the first multiplicity of elements including interface elements and non-interface elements, the method comprising reading source code, isolating at least selected ones of the interface elements from the source code; and identifying, and displaying to a user, only those functional relationships which are defined between the isolated interface elements, wherein customer-specific information is used to perform identifying.

Also provided, in accordance with certain embodiments of the present invention, is a method for analyzing a computer program comprising a multiplicity of computer program elements including impacting elements and impacted elements, wherein the impacting elements impact upon the impacted elements, the method comprising identifying a plurality of impacts between at least one impacting element and at least one impacted element, prioritizing the plurality of impacts; and displaying at least some of the plurality of impacts in relation to the computer program's behavior rather than in relation to the computer program's structure, and so as to prioritize highly prioritized impacts.

Further in accordance with certain embodiments of the present invention, the method also comprises using the customer-specific information to make an a priori identification of interface elements between which no functional relationship exists.

Still further in accordance with certain embodiments of the present invention, the method also comprises using the customer-specific information to eliminate impossible functional relationships given the customer-specific information.

Additionally in accordance with certain embodiments of the present invention, the identifying comprises impact analysis identifying impacts occurring between a user-selected impacting element and elements impacted thereby.

Further in accordance with certain embodiments of the present invention, the identifying comprises root cause analysis identifying impacts occurring between a user-selected impacted element and elements impacting it.

Additionally in accordance with certain embodiments of the present invention, the prioritizing of impacts comprises ranking of elements participating in impacts identified in the identifying.

Further in accordance with certain embodiments of the present invention, the isolating comprises isolating at least a portion of the impacting interface elements and wherein the impacting interface elements comprise at least one of the following types of impacting interface elements: Customization data; and Code changes.

Further in accordance with certain embodiments of the present invention, the identifying comprises performing root cause analysis by identifying at least one impacting interface element having a functional relationship with a user-selected impacted interface element.

Further in accordance with certain embodiments of the present invention, the prioritizing comprises selection of a subset of impacts which are deemed important and displaying only the subset of impacts.

Still further in accordance with certain embodiments of the present invention, the identifying comprises performing impact analysis by identifying at least one impacted interface element having a functional relationship with a user-selected impacting interface element.

Further in accordance with certain embodiments of the present invention, the computer program comprises a collection of statements written in a computer language and wherein each element comprises at least one computer language statement.

Still further in accordance with certain embodiments of the present invention, the isolating comprises isolating at least a portion of the impacting interface elements and wherein the impacting interface elements comprise at least one of the following types of impacted interface elements: at least one field in a display screen; at least one error message; a read-type interaction with a database; a write-type interaction with a database; and a call to an external function.

Additionally provided, in accordance with certain embodiments of the present invention, is a system for analyzing a computer program comprising a first multiplicity of elements having a second multiplicity of functional relationships defined therebetween, the first multiplicity of elements including interface elements and non-interface elements, the apparatus comprising a source code analyzer operative to isolate at least selected ones of the interface elements from the source code; and a functional relationship display unit operative to identify only those functional relationships which are defined between the isolated interface elements, wherein customer-specific information is used to identify the functional relationships.

Further in accordance with certain embodiments of the present invention, isolating comprises isolating at least one interface element pertaining to a user-selected program and wherein the identifying comprises performing program investigation by identifying only those functional relationships defined between the isolated interface elements pertaining to the user-selected program.

Still further in accordance with certain embodiments of the present invention, the user-selected program comprises a user-selected transaction and the at least one interface element pertaining to a user-selected program comprises all interface elements pertaining to the user-selected transaction.

Further in accordance with certain embodiments of the present invention, the analyzer is operative to isolate at least a portion of the impacting interface elements.

Still further in accordance with certain embodiments of the present invention, the analyzer is operative to isolate at least a portion of the impacted interface elements.

Further in accordance with certain embodiments of the present invention, the display unit is operative to perform root cause analysis by identifying at least one impacting interface element having a functional relationship with a user-selected impacted interface element.

Still further in accordance with certain embodiments of the present invention, the display unit is operative to perform impact analysis by identifying at least one impacted interface element having a functional relationship with a user-selected impacting interface element.

Also provided, in accordance with certain embodiments of the present invention, is a software system analysis system comprising a static analyzer operative to analyze a computer program, written in a programming language defining a set of syntactical elements and having a user interface defining a set of user-interface elements having members, including identifying at least one of the syntactical elements which is associated with an impact which relates to a user; and a user-comprehensible display displaying at least the impact-associated syntactical element in association with a relevant member of the set of user-interface elements.

Further in accordance with certain embodiments of the present invention, the at least one syntactical element associated with an impact which relates to a user comprises an impacting syntactical element which generates an impact relevant to the user.

Still further in accordance with certain embodiments of the present invention, the at least one syntactical element associated with an impact which relates to a user comprises an impacted syntactical element which is transitively functionally dependent on an impact relevant to the user.

Further in accordance with certain embodiments of the present invention, the method also comprises using customer-specific information to perform the identifying including using the customer-specific information to make an a-priori identification of interface elements between which no functional relationship exists; and using the customer-specific information to eliminate impossible functional relationships given the customer-specific information, wherein the isolating comprises isolating at least a portion of the impacting interface elements; and isolating at least a portion of the impacted interface elements.

Also provided, in accordance with certain embodiments of the present invention, is a system for analyzing a computer program comprising a multiplicity of computer program elements including impacting elements and impacted elements, wherein the impacting elements impact upon the impacted elements, the system comprising an impact identifier operative to identify a plurality of impacts between at least one impacting element and at least one impacted element; and an impact display generator operative to prioritize the plurality of impacts and to generate a representation, for display, of at least some of the plurality of impacts in relation to the computer program's behavior rather than in relation to the computer program's structure, wherein the representation prioritizes highly prioritized impacts.

It is appreciated that interface elements of a computer program may comprise elements (e.g. sets of one or more computer program statements) within the computer program which a user of the computer program, who is unfamiliar with the computer program's source code, is aware of. In contrast, non-interface elements of the same computer program may comprise sets of one or more computer program statements which a user unfamiliar with the source code would not be aware of, such as assignment statements, control flow statements (e.g., if statements or case statements), procedure calls and procedure definitions, and other internal variables. A computer program's “interface elements” include both “impacting” interface elements which are elements of input to the computer program such as command line arguments, read-from-file or read-from-database statements, read-from-screen or read-from-terminal statements and “impacted” interface elements which are elements generated by the computer program, such as screens or screen fields, error messages, read-type or write-type interactions with databases, and calls to external functions, or aspects thereof.

According to certain embodiments of the invention, responsive to a query, all statements pertinent to the query are first identified. For example, all relevant impacting statements may be identified for a root cause analysis type query, or all relevant impacted statements might be identified for an impact analysis type query. Subsequently, the statements may be ranked by importance. A subset of the relevant impacting statements may be designated as important and only the important statements may then be displayed to a user in descending order of rank.

Any suitable processor, display and input means may be used to process, display, store and accept information, including computer programs, in accordance with some or all of the teachings of the present invention, such as but not limited to a conventional personal computer processor, workstation or other programmable device or computer or electronic computing device, either general-purpose or specifically constructed, for processing; a display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and /or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention.

Any trademark occurring in the text or drawings is the property of its owner and occurs herein merely to explain or illustrate one example of how an embodiment of the invention may be implemented.

### BRIEF DESCRIPTION OF THE DRAWINGS

Certain embodiments of the present invention are illustrated in the following drawings:

FIG. 1 is a simplified flowchart illustration of a computer program analysis method constructed and operative in accordance with certain embodiments of the present invention;

FIG. 2 is a simplified flowchart illustration of a method for performing the impact analysis of FIG. 1, in accordance with certain embodiments of the present invention;

FIG. 3 is a simplified flowchart illustration of a method for performing the root cause analysis of FIG. 1, in accordance with certain embodiments of the present invention;

FIG. 4 is a simplified flowchart illustration of a method for performing the program investigation of FIG. 1, in accordance with certain embodiments of the present invention;

FIGS. 5-17 are simplified pictorial illustrations of examples of computer display screens which together form a suitable user interface facilitating performance of the impact analysis, root cause analysis and program investigation processes of FIG. 1 for an example application of the invention shown and described herein in which the input program is SAP ERP. In particular:

FIGS. 5-11 are simplified pictorial illustrations of computer display screens which together form a suitable user interface facilitating performance of the impact analysis of FIG. 1. In particular:

FIG. 5 is a simplified pictorial illustration of a computer display screen enabling a user of the system of FIG. 1, to define a change request to be gotten in step 200 of FIG. 2;

FIG. 6 is a simplified pictorial illustration of an example of a computer display screen illustrating all transactions affected by the change requested by the user using the computer display screen of FIG. 5;

FIG. 7 is a simplified pictorial illustration of an example of a computer display screen listing all input program screens (within a transaction selected, using the screen of FIG. 6, by a user of the system of FIG. 1, from among the various transactions in the input program) which are impacted by the change requested by the user using the screen of FIG. 5;

FIG. 8 is a simplified pictorial illustration of an example of a computer display screen listing all fields within an input program screen selected by a user of the system of FIG. 1, using the screen of FIG. 7, which are affected (e.g. added, removed, or, most commonly, changed in value) by the change requested by the user using the screen of FIG. 5;

FIG. 9 is a simplified pictorial illustration of an example of a computer display screen listing all error messages associated with an input program screen selected by a user of the system of FIG. 1, using the screen of FIG. 7, which are affected (e.g. added, removed, or modified) by virtue of the change requested by the user using the screen of FIG. 5;

FIGS. 10A-10B, taken together, form a simplified pictorial illustration of an example of a computer display screen listing all table accessing operations associated with an input program screen selected by a user of the system of FIG. 1, using the screen of FIG. 7, which are affected by the change requested by the user using the screen of FIG. 5. For example, data written to or deleted from a database may be affected by (functionally dependent upon) earlier input;

FIGS. 11A-11B, taken together, form a simplified pictorial illustration of an example of a computer display screen listing all user exits associated with an input program screen selected by a user of the system of FIG. 1, using the screen of FIG. 7, which are affected by the change requested by the user using the screen of FIG. 5. For example, the call statement to the user exit may functionally depend on the inputs;

FIGS. 12-14 are simplified pictorial illustrations of computer display screens which together form a suitable user interface facilitating performance of the root cause analysis step of FIG. 1. In particular:

FIG. 12 is a simplified pictorial illustration of an example of a computer display screen displaying a list of errors occurring during display of a particular user-selected screen within a particular user-selected transaction, the list of errors enabling a user of the system of FIG. 1 to select, e.g. by finding or by sorting, an error message to be “solved” e.g., for which a root cause is to be determined by performing the root cause analysis step 110 of FIG. 1;

FIGS. 13A-13B, taken together, form a simplified pictorial illustration of an example of a computer display screen listing all input program screens under which at least one source or root cause of the error message selected in FIG. 12 has been found by the system;

FIGS. 14A-14B, taken together, form a simplified pictorial illustration of an example of a computer display screen listing all possible causes of a user-specified error message occurring within a user-specified transaction, categorized by screen, preceding documents, master data and customizations;

FIGS. 15-17 are simplified pictorial illustrations of computer display screens which together form a suitable user interface facilitating performance of the program investigation step of FIG. 1. In particular:

FIG. 15 is a simplified pictorial illustration of an example of a computer display screen allowing a user of the system of FIG. 1 to select a transaction to be investigated by the program investigation step of FIG. 1, the transaction being user-selected from among a multiplicity of transactions existing within an input program;

FIG. 16 is a simplified pictorial illustration of an example of a computer display screen allowing a user to select one or more input program screens within the transaction selected in FIG. 15;

FIG. 17 is a simplified pictorial illustration of an example of a computer display screen listing all user exits which “belong to” the input program screen selected by the user in FIG. 16, i.e. all user exits which occur while the input program screen selected in FIG. 16 is displayed to the user; and

FIG. 18 is a simplified flowchart illustration of a work session using the system of FIGS. 1-4.

### DETAILED DESCRIPTION OF VARIOUS EMBODIMENTS OF THE INVENTION

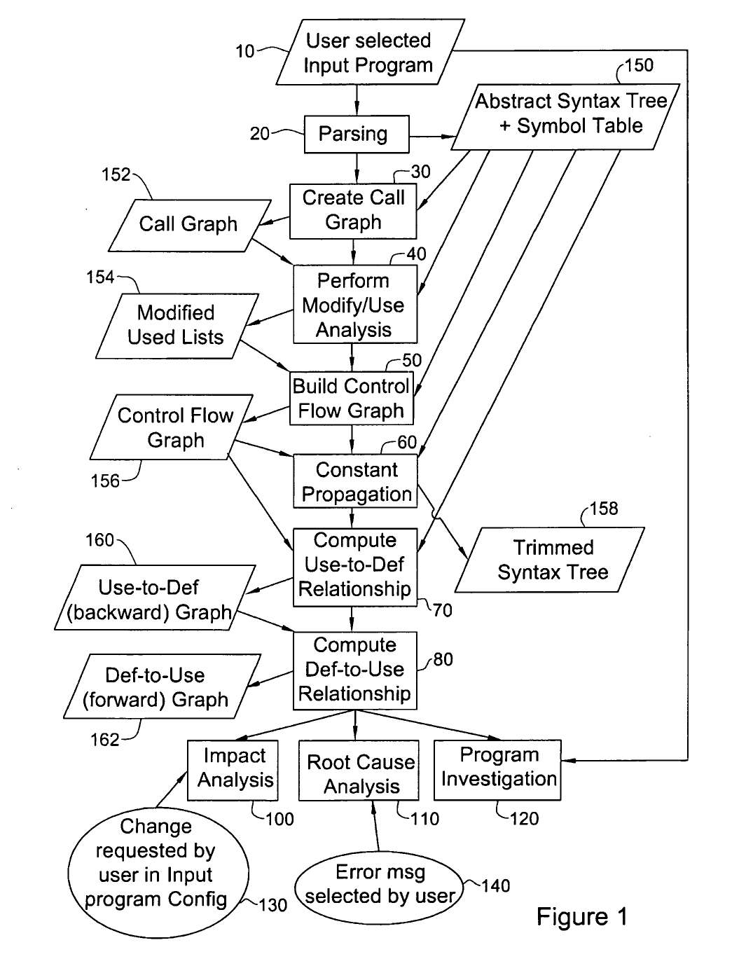

Reference is now made to FIG. 1 which is a simplified flowchart illustration of a computer program analysis method constructed and operative in accordance with certain embodiments of the present invention. As shown, the input to the method of FIG. 1 is an input program 10 which may comprise substantially any computer program such as but not limited to firmware; system software including but not limited to operating systems; packaged applications; proprietary home grown software systems; ERPs; billing programs; CRM programs; application software including but not limited to management software, including legal management programs, transportation management programs, manufacturing control programs and business management programs such as one of those commercially available from SAP; financial programs including accounting programs; office programs including word processors; security programs including cryptographic programs; graphics programs; communications programs; and entertainment programs including games.

The structure of the input program is then analyzed as is known in the art. Typically, the input to the analysis process comprises the source code of the software, including the original application source code, any customer extensions and modifications thereof, and any data from any external or internal configurations thereto or parameters used thereby. External and internal configurations and/or parameters are preferably employed to evaluate and to propagate the values of program variables and data structures. These values are used, inter alia, to evaluate control flow splits such as “if” statements, which in turn eliminate dead code, and to evaluate dynamic pieces of code such as dynamic procedure calls and dynamic messages.

In the illustrated embodiment, the input program is first parsed (step 20). Any suitable parsing method may be used; typically the input program first undergoes lexical and/or grammatical analysis and subsequently, a representation of the program, typically including an abstract syntax tree and symbol table 150, is generated. A suitable method for parsing the program, thereby to generate the above outputs, is described in Compilers: Principles, Techniques, and Tools (2nd Edition) by Alfred V. Aho, Monica S. Lam, Ravi Sethi, Jeffrey D. Ullman, Addison-Wesley Longman Publishing Co., Inc. Boston, Mass., USA, 2006, Chapters 3 (Lexical Analysis), 4 (Syntax Analysis) and 7.6 (Symbol Table). The symbol table is typically generated together with the abstract syntax tree and in general, the order of operations shown and described in the present specification and illustrated in the drawings, is merely exemplary and is not intended to be limited.

A call graph 152 is then created from the abstract syntax tree and symbol table 150 (step 30). A suitable method for performing step 30 is described in Chapter 19.1, entitled “Interprocedural Control-Flow Analysis: The Call Graph”, in Steven Muchnick, Advanced Compiler Design and Implementation, Morgan Kaufmann; 1ST Ed., Aug. 1, 1997.

Modify/use analysis is then performed, in step 40, on the call graph 152, thereby to generate modified/used lists 154. A suitable method for performing step 40 is described in W. Landi, B. G. Ryder, and S. Zhang, “Interprocedural side effect analysis with pointer aliasing”, in PLDI 93: Programming Language Design and Implementation, ACM, 1993, pages 56-67.

A control flow graph 156 is constructed (step 50). A suitable method for building a control flow graph is described in Notes on Representation and Analysis of Software, by Mary Jean Harrold (Georgia Institute of Technology) and Gregg Rothermel (Oregon State University), Dec. 31, 2002, http://www-static.cc.gatech.edu/˜harrold/8803/Readings/rep_and_analy.pdf.

In step 60, constant propagation is performed on the control flow graph 156 thereby to generate a trimmed version 150 of the syntax tree 150. The abstract syntax tree and symbol table 150 generated in step 20 are typically inputs to almost all steps as shown, including step 60. A suitable method for performing step 60 is described in “Constant propagation with conditional branches”, Mark N. Wegman and F. Kenneth Zadeck, TOPLAS (ACM Transactions on Programming Languages and Systems), Vol. 13 (2), Apr. 1991, pp. 181-210; and in “Symbolic path simulation in path-sensitive dataflow analysis”, Hari Hampapuram, Yue Yang, Manuvir Das, 6th ACM SIGPLAN-SIGSOFT Workshop on Program Analysis for Software Tools and Engineering, 2006, pp. 52-58.

Preferably, propagation of configuration values is performed incrementally. If the input program is a SAP program, for example, there may be a very large number of constants operationalizing the original SAP program. These customization constants are typically defined by the user or whoever is configuring on his behalf, who is expected to fill many customization tables with his own desired configuration values. The user or whosoever is configuring on his behalf may initially define only a small subset of the large number of configuration values s/he will eventually define, e.g. once the system is deployed to customer premises. In this case, preferably, only those values that are currently known are initially propagated to variables and control-flow splits. Later, e.g. once the system is deployed to customer premises, additional configuration values may become known in which case further constant propagation may be performed.

When a particular scenario is statically analyzed, all specific known inputs for that scenario are typically propagated.

Use-to-def and def-to-use relationships are then computed, by steps 70 and 80 respectively, and typically represented and stored in use-to-def graph 160 and def-to-use graph 162. A suitable method for performing steps 70 and 80 is described in the above referenced Harrold and Rothermel documents.

More generally, it is appreciated that the preliminary analysis of input program 10, preceding impact analysis 100, root cause analysis 110 and program investigation 120, may be performed in accordance with conventional compiling techniques e.g. as described in the above-referenced text entitled Compilers: Principles, Techniques, and Tools. While the embodiment shown and described herein generates and uses some or all of the following structures to represent the input program: abstract syntax tree and symbol table 150, call graph 152, modified/used lists 154, control flow graph 156, trimmed syntax tree 158, use-to-def graph 160 and def-to-use graph 162, it is appreciated that alternatively or in addition, other structures may be generated and used. It is appreciated that the source code of a conventional compiler of the input program, if available, may be used to perform steps 20-80 of FIG. 1 or to otherwise generate a data structure representing the input program 10, so as to enable queries on the program, such as but not limited to impact analysis, root cause analysis, and/or investigation of input program 10, to be carried out.

It is appreciated that alternatively or in addition to the impact analysis 100, root cause analysis 110 and program analysis 120, other analyses of the input program 10 may be provided, such as but not limited to test copying and application mining. The three query-supporting analysis modules 100, 110 and 120 described in detail herein are merely examples of the many possible query supporting analysis modules that may be provided.

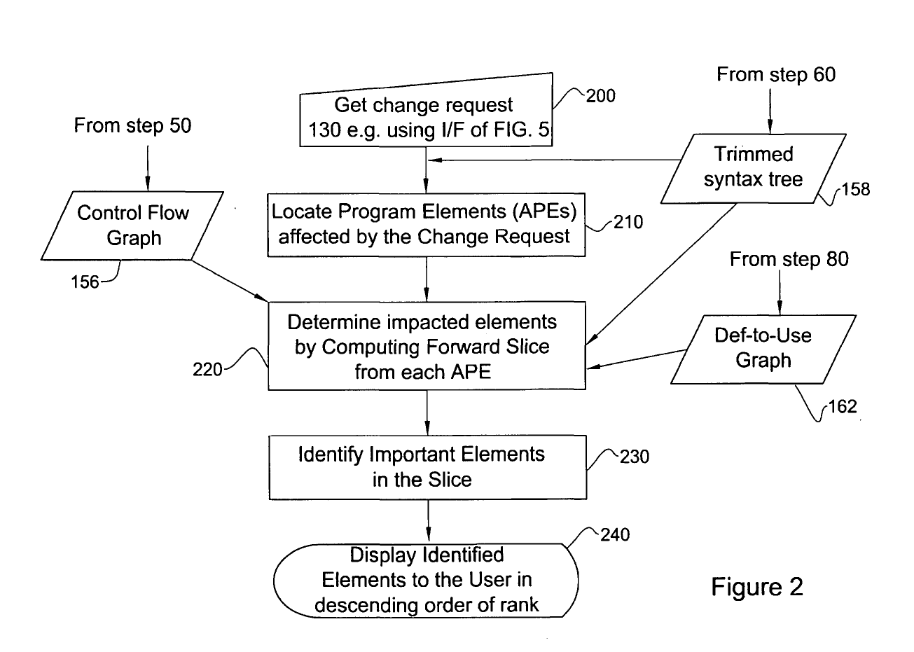

FIG. 2 is a simplified flowchart illustration of a method for performing the impact analysis step of FIG. 1, in accordance with an embodiment of the present invention. The term “static impact analysis” as used herein, comprises identification of at least some functionally dependent portions of the functional behavior of an input program resulting from source code changes and/or modifications of the input program's customization values and/or modifications of parametric values. The term “forward slicing” as used herein refers to slicing performed on a def-to-use graph, as opposed to “backward slicing” which is performed on a use-to-def graph. The method of FIG. 2 serves a user who desires to change the customization of the input program.

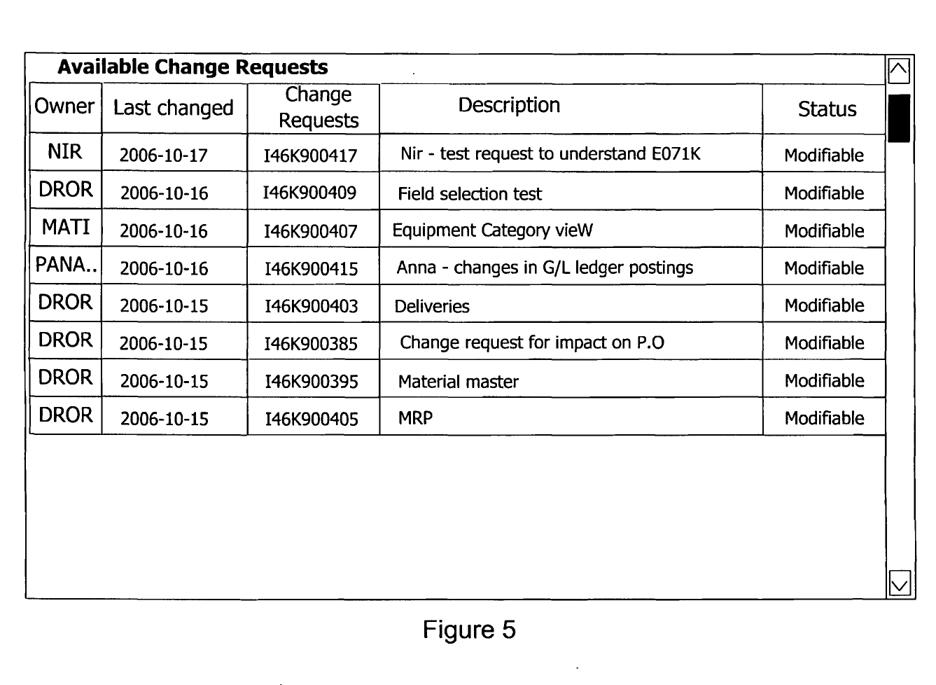

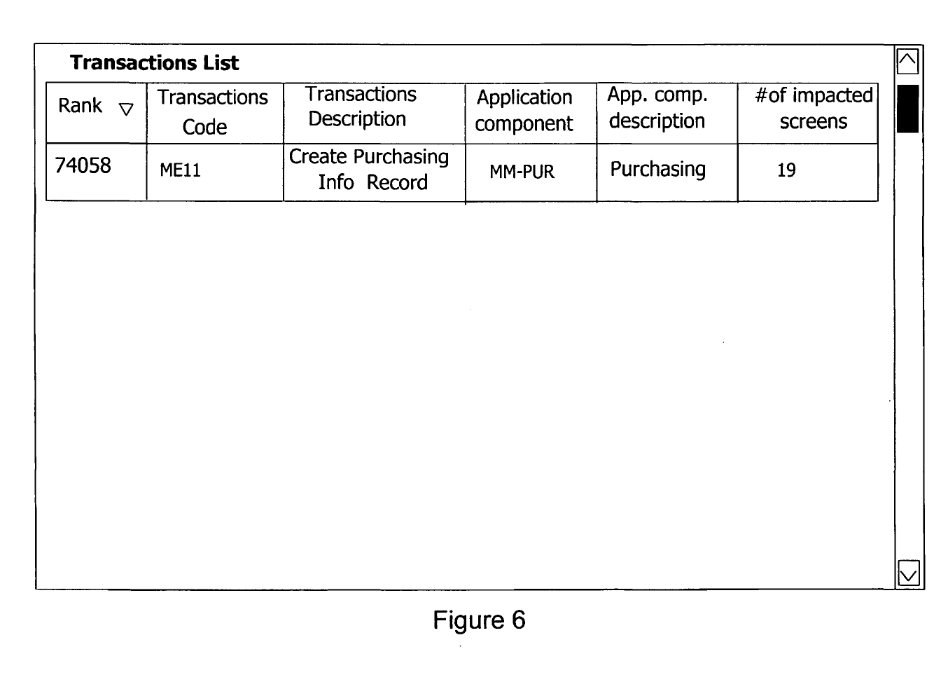

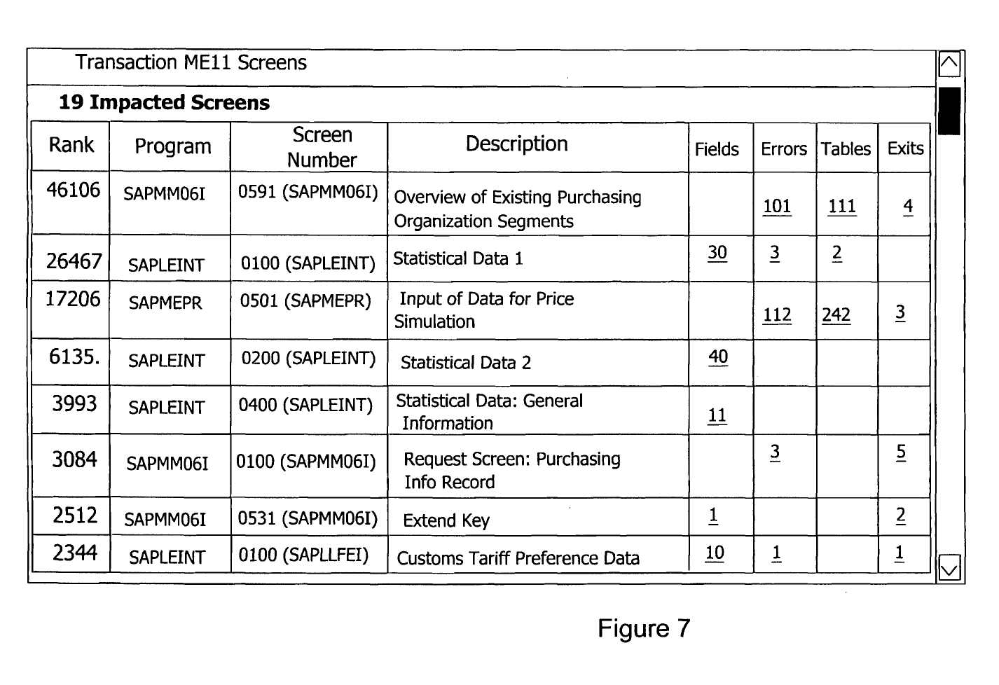

In FIG. 2, the impact of a change, or change request selected by a user (step 200), e.g. using the interface of FIG. 5, is analyzed. Initially all software statements that read the customization input which the user wishes to change are located in the input program. Typically, the control flow graph contains two sets of edges: (1) All the edges from the def-to-use graph 162, and (2) an edge from each control flow statement s1 to each statement s2 that is controlled by s1; In step 220, transitive forward slicing is performed on a graph that contains all such edges, interconnecting all statements reachable from the statements identified in step 210.

In step 230, the slice is traversed and important elements in the slice are identified. For example, if the input program, such as SAP ERP, is written in ABAP, the important elements may include, among others, the following:
(a) ABAP statements that assign a value to a screen field;
(b) ABAP statements that read from or write to a database;
(c) ABAP statements that call a user exit; and
(d) ABAP statements that generate an error message.
   If the input program is a word processor, the input elements may for example include error messages, formatting statements or both.

The important elements are then ranked, so as to be displayed in descending order of rank (step 240).

According to certain embodiments of the invention, all response sets to all queries presented to the system, such as but not limited to impact analysis queries, root-cause analysis queries and program investigation queries, are ranked and are then displayed in descending order of rank. However, alternatively, some or all of the query processing modules of the system of the present invention may not compute rank and may not display results in descending order of rank. For example, the system of the present invention may, in contrast to the illustrated embodiment, include five query modules, such as IA, RCA, PI, test copying and application mining, of which only the IA module may have a ranking functionality.

Typically, rank is computed as part of the slicing process. As an individual statement s1 is being added to the slice, its rank is computed as follows: The maximal rank of all statements having incoming edges to s1 in the slice, minus a constant decay amount, is set as s1's initial rank. Then, a contribution depending on s1 is added to the rank of s1. s1's contribution is computed depending on its type and context. Each statement type is assigned a weight, some of which may be sensitive to the context of the statement, such as the function in which the statement resides. For instance, an “INSERT to table T1” statement may be assigned a higher weight than an “INSERT to table T2” statement based on importance of the respective tables T1 and T2.

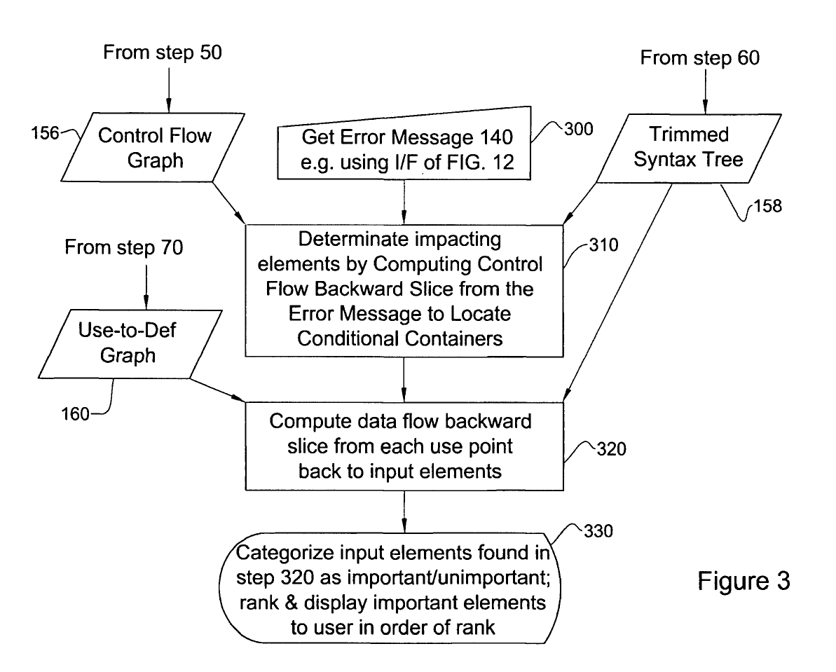

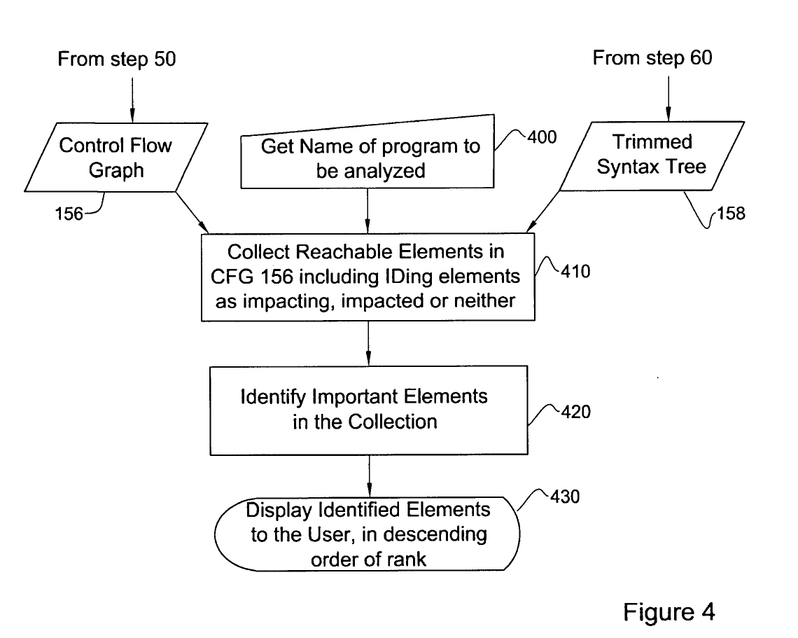

It is appreciated that the above ranking process is suitable for implementing all ranking steps shown and described herein in including step 240 of FIG. 2, step 330 of FIG. 3 and step 430 of FIG. 4.

Transactions may be ranked, e.g. by summing up the ranks of all the important elements within the transaction, and displayed in descending order of rank.

A subset of the impacted elements may be reported to the user as impacted elements. Elements of the program that are reported to the user as impacted elements are called important elements. If the input program 10 comprises a SAP ERP program, important elements may be defined as:
(1) Assignments to screen fields
(2) Calls to user exits
(3) Statements that generate error messages
(4) Statements that access database tables

For large input programs such as SAP ERP, constant propagation is provided (module 60 in FIG. 1). These measures, separately and a fortiori in combination, expedite impact analysis.

FIG. 3 is a simplified flowchart illustration of a method for performing the root cause analysis step of FIG. 1, in accordance with certain embodiments of the present invention. The input to the root cause analysis method of FIG. 3 may be a user-designated error message (step 300) for which it is desired to find a root cause i.e. at least one impacting elements within the input program which caused that error message. Alternatively, the input to the method of FIG. 3 may be any other behavior of the input program which is either (a) designated by a user to be problematic, or (b) known to be erroneous such an division by 0, or (c) designated as behavior that requires explanation, such as the program's having reached a particular, designated line in its code such as a go-to line or other line which is regarded as an undesirable or emergency provision.

Typically, two slicing steps are now performed, steps 310 and 320. The first slicing step comprises traveling back up the edges of the control flow graph, until conditional statements are reached (alternatively, this step may be performed by backward traversal of a domination graph e.g. as described in ACM Transactions on Programming Languages and Systems (TOPLAS) Volume 19, Issue 3 (May 1997) Pages: 462-491, Keshav Pingali and Gianfranco Bilardi, 1997, ISSN:0164-0925.

The second slicing step comprises traveling the edges of the use-to-def graph until input statements are reached. Specifically, in step 310, the control flow graph 156 of FIG. 1 is used to compute a control flow backward slice, i.e. to compute a slice from the error message generating statement, or other problematic statement identified in step 300, backward. The output of this step is a collection of “conditional containers”, such as if-then-else statement blocks and similar conditional statement blocks. The slicing process operates on the control flow graph 156 of FIG. 1, however, slicing is backward i.e. the data dependency edges that are used are use-to-def edges.

The output of step 310 is a collection of “use points”. A statement s1 is considered a “use point” of a variable v1 if s1 uses v1; in contrast, s2 is a “definition point” of v2 if s2 defines v2. Backward slicing proceeds from, for example, a statement using two variables v1 and v2, to the statements that are the definition points of v1 and v2. If v1 is defined in terms of u1 and u2 e.g. as a sum thereof (i.e. if the definition point of v1 is the following assignment statement which defines v1 and uses u1 and u2: v1=u1+u2) then slicing continues back to the definition of u1 and of u2 and so on.

In step 320, the use-to-def graph 160 of FIG. 1 is used to compute a data flow slice from each use point identified in step 310, back to the relevant input elements of the input program.

Methods for slicing are known in the art and are described e.g. in:
(1) Weiser, M., “Program slicing,” IEEE Transactions on Software Engineering SE-10(4) pp. 352-357 (July 1984);
(2) Susan Horwitz, Thomas Reps, David Binkley, “Interprocedural slicing using dependence graphs”, ACM Transactions on Programming Languages and Systems (TOPLAS), 12(1), pp. 26-60, January 1990; and
(3) “Speeding up slicing”, Proceedings of the 2nd ACM SIGSOFT symposium on Foundations of software engineering, New Orleans, La., United States, pp. 11-20, 1994.

The input elements are defined as the important elements for the root cause analysis method of FIG. 3. For example, if the input program on which root cause analysis is being performed is SAP ERP, the important elements may comprise screen field value assigning statements and select statements.

In step 330, input elements found in step 320 are displayed to the user, typically in descending order of rank.

FIG. 4 is a simplified flowchart illustration of a method for performing the program investigation step of FIG. 1, in accordance with certain embodiments of the present invention. A user supplies the name of a program to be analyzed in step 400. The program's control flow graph is analyzed in step 410 to collect therewithin, all reachable elements i.e. all statements therein which are connected by a path from the first statement therein. This step serves to remove from consideration, all dead code. Any suitable traversal method can be used to find all reachable elements such as a DFS (depth first search) or BFS (breadth first search).

From among the reachable elements, only important elements are retained (step 420). For example, for SAP ERP, only (a) statements which assign a value to a screen field; (b) statements which read from or write to a database; (c) statements which call a user exit; and (d) statements which generate an error message, may be retained. In step 430, the retained statements are displayed, typically in descending order of rank.

FIGS. 5-17 are simplified pictorial illustrations of examples of computer display screens which together form a suitable user interface facilitating performance of the impact analysis, root cause analysis and program investigation steps of FIG. 1 for an example application of the invention shown and described herein in which the input program is SAP ERP. In particular:

FIGS. 5-11 are simplified pictorial illustrations of computer display screens which together form a suitable user interface facilitating performance of the impact analysis step of FIG. 1. In particular:

FIG. 5 is a simplified pictorial illustration of a computer display screen enabling a user of the system of FIG. 1, to define a change request to be gotten in step 200 of FIG. 2. In FIG. 5, a selection of changes, e.g. all change requests available to the system, are displayed. Typically, the screen content of FIG. 5 comprises a list of all available released or modifiable change requests, which requests have yet to be transported to the corresponding target SAP client.

Typically, data pertaining to each change request is displayed e.g. each change request's last date of change, owner, description and status are displayed. The user can select a set of one or more selected change requests e.g. by clicking on change requests s/he wishes to select. When the user finalizes her selection, e.g. by clicking on a “next” button, impact analysis according to FIG. 2 is performed by the system. If the user selects more than one change (or change requests) then the impact of all these changes together is considered by the system.

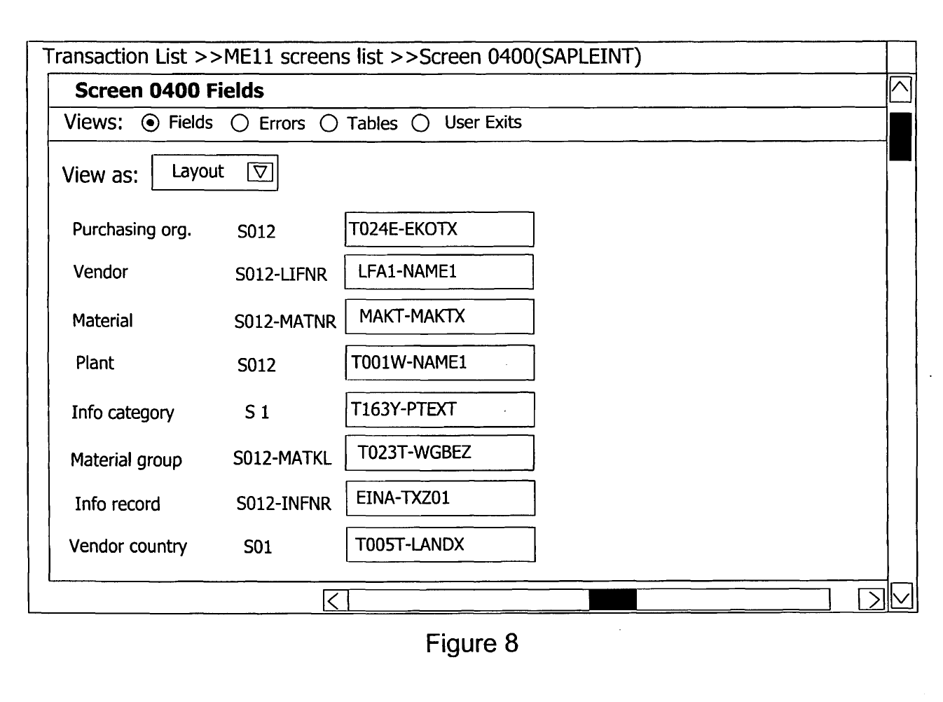

FIG. 6 is a simplified pictorial illustration of an example of a computer display screen illustrating all transactions affected by the change/s requested by the user using the computer display screen of FIG. 5. In the illustrated example, only one transaction, whose code is ME11, was impacted by a certain change requested by a certain user. Within that transaction, the number of impacted screens, in the illustrated example, was 19. If several or many transactions had been affected, these transactions would have been displayed to the user, on the screen of FIG. 6, in descending order of rank. The rank of each transaction is typically displayed in the “rank” column on the left of the screen.

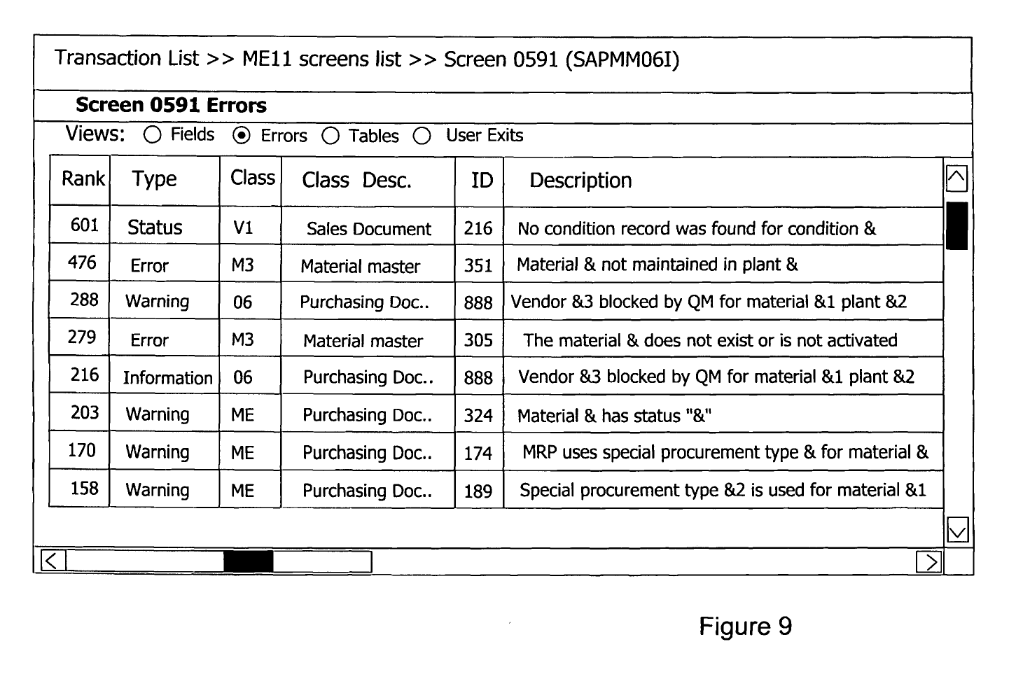

FIG. 7 is a simplified pictorial illustration of an example of a computer display screen listing all input program screens (within a transaction selected, using the screen of FIG. 6, by a user of the system of FIG. 1, from among the various transactions in the input program) which are impacted by the change requested by the user using the screen of FIG. 5. In the illustrated example, particulars of 19 impacted screens would be shown in the screen display of FIG. 7, only some of which are shown to facilitate simplicity of presentation.

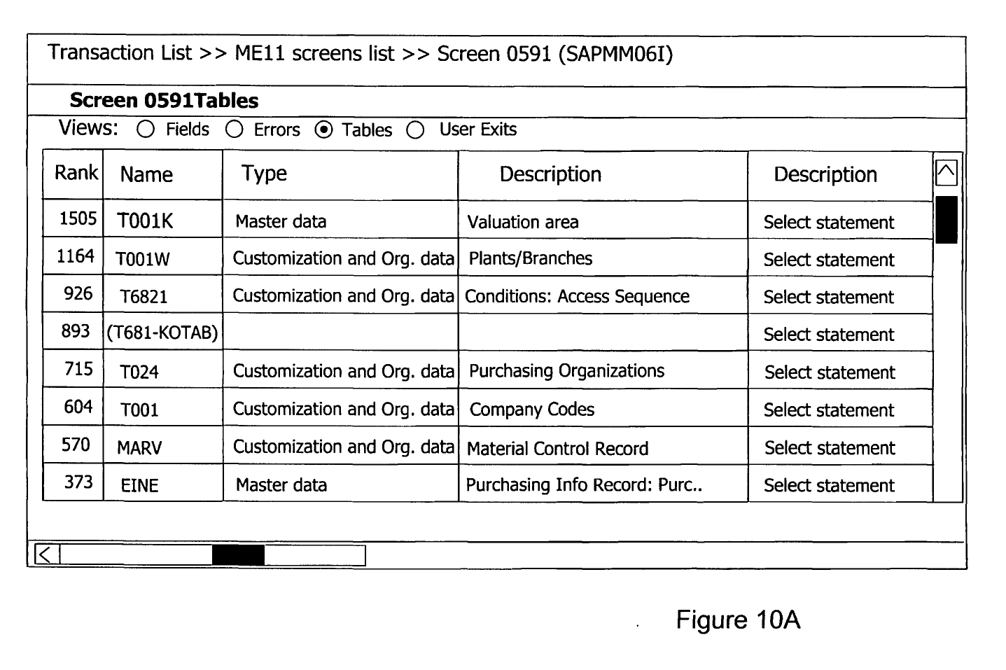

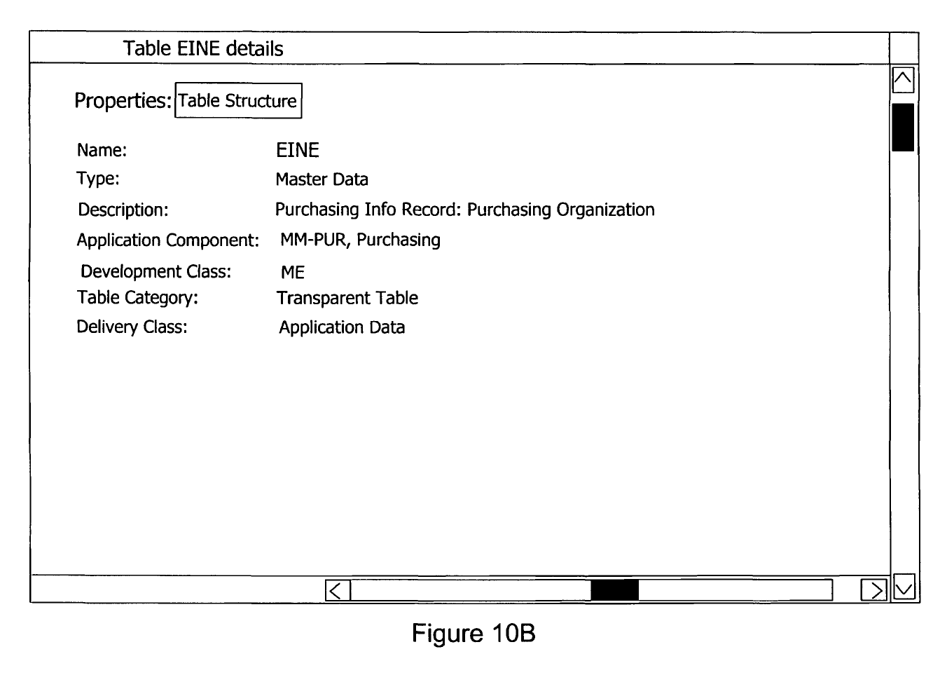

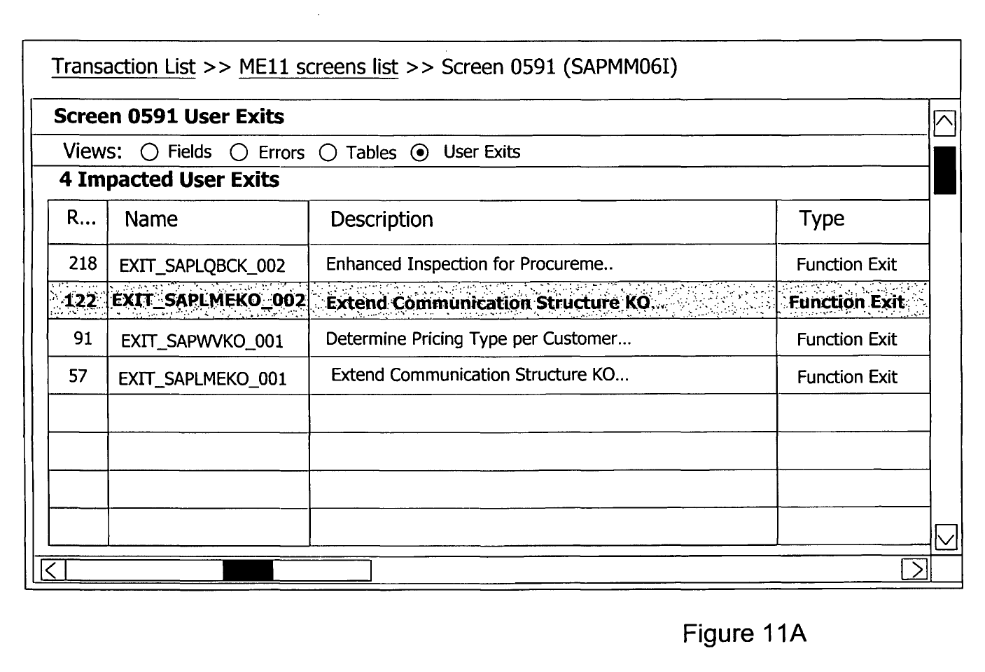

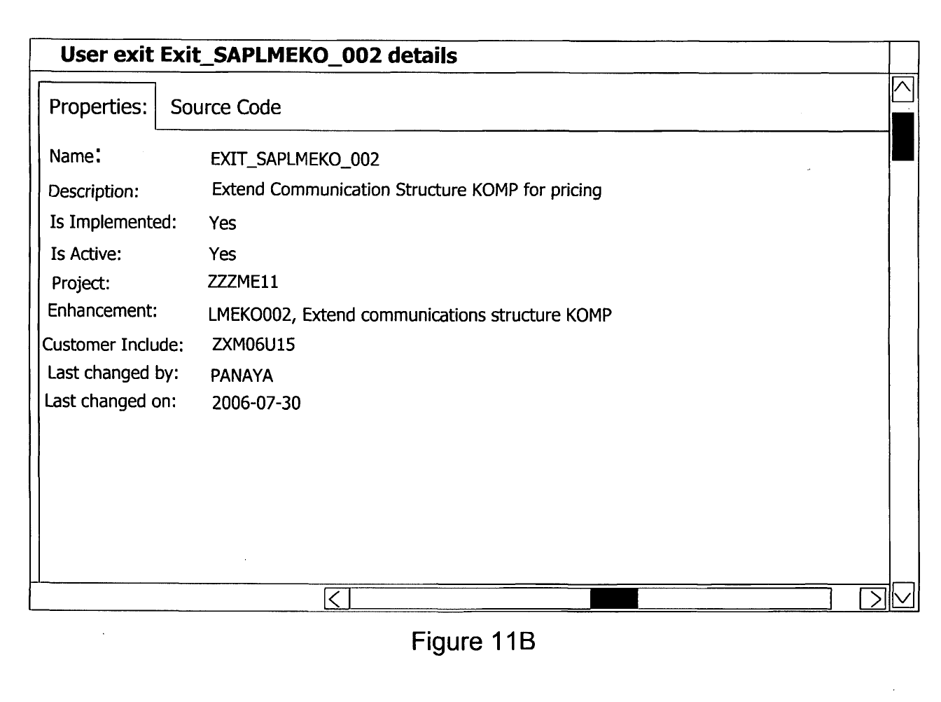

Preferably, all analysis results are presented to users in terms of the functional behavior of the input program and not in terms of the computer language in which the input program is written. Therefore, the screen display of FIG. 7 preferably displays, for each impacted display screen of the input program, not only a list of the screen fields impacted therewithin (FIG. 8), but also a list of error messages generated while an individual impacted screen is being displayed to a user of the input program (FIG. 9), a list of tables accessed (written to or read from) while the screen is being displayed (FIG. 10A), and a list of user exits employed while the screen is being displayed (FIG. 11A). In the illustrated example, the screen subject of the first display row in FIG. 7, screen 0591, has 101 impacted errors, all of which are displayed, in descending order of rank, in the screen of FIG. 9 (for simplicity of presentation, only some of these are actually reproduced in the figure). Screen 0591 has 111 impacted tables, all of which are displayed, in descending order of rank, in the screen of FIG. 10A (for simplicity of presentation, only some of these are actually reproduced in the figure). Screen 0591 has 4 impacted user exits, all of which are displayed, in descending order of rank, in the screen of FIG. 11.

As described above, FIG. 8 is a simplified pictorial illustration of an example of a computer display screen illustrating all impacted fields within an input program screen (No. 400, in the fifth row of FIG. 7, in the illustrated example) selected by a user of the system of FIG. 1. The fields shown in FIG. 8 are affected (e.g. added, removed, or, most commonly, changed in value) by the change requested by the user using the screen of FIG. 5. Preferably, impacted screen fields are illustrated rather than merely being listed. In FIG. 8, impacted screen fields are shown exactly in the positions in which they appear on the screen. Impacted and non-impacted screen fields may be differentiated graphically, e.g. by coloring or otherwise highlighting the impacted screen fields.

As described above, FIG. 9 is a simplified pictorial illustration of an example of a computer display screen listing all error messages associated with an input program screen selected by a user of the system of FIG. 1, using the screen of FIG. 7, which are affected (e.g. added, removed, or modified) by virtue of the change requested by the user using the screen of FIG. 5.

As described above, FIG. 10A is a simplified pictorial illustration of an example of a computer display screen useful in performing impact analysis in accordance with certain embodiments of the present invention. The display of FIG. 10A lists all table accessing operations associated with an input program screen selected by a user of the system of FIG. 1, using the screen of FIG. 7, which are impacted by the change requested by the user using the screen of FIG. 5. The screen of FIG. 10A lists the 111 impacted table access statements which “belong to” screen number 0591 in FIG. 7 (i.e., the 111 impacted table statements which read to or write from tables, while screen number 0591 is being displayed to the user. The type of each statement is indicated in the “statement” column on the right (either “select”, “insert”, “update” or “delete”). In the illustrated example, most of the impacted table statements happen to be select statements.

The screen content of FIG. 10B, which may be displayed concurrently with the screen content of FIG. 10A, comprises a display of characteristics of a table accessed in a user-selected one of the impacted table statements shown in FIG. 10A.

As described above, FIG. 11A is a simplified pictorial illustration of an example of a computer display screen listing all user exits associated with an input program screen selected by a user of the system of FIG. 1, using the screen of FIG. 7, which are impacted by the change requested by the user using the screen of FIG. 5. Typically these are the user exits whose call statements are in the forward slice of the change request defined by the user. The screen of FIG. 11A lists the 4 impacted user exits which “belong to” screen number 0591 in FIG. 7 (i.e., the 4 impacted user exits that may be called while screen number 0591 is being displayed to the user). These user exits are either called if the change is made and not otherwise, or they were called until the change was made or requested whereas if the change is made, they will not be called.

The screen content of FIG. 11B, which may be displayed concurrently with the screen content of FIG. 11A, comprises a display of characteristics of a user-selected one of the impacted user exits shown in FIG. 11A.

As shown in FIGS. 9-11B, the system of the present invention is particularly suited to high-level users of an input program who configure the input program, but who are not familiar with the computer language in which the input program is written. Preferably, all analysis results are presented to users in terms of the functional behavior of the input program and not in terms of the computer language in which the input program is written. For example, presentation of impacted elements may be grouped by association to an element of the functional behavior of the input program. In particular, the system of the present invention may include an interface enabling a user thereof to select a display screen of the input program and to receive a list of all impacted elements, e.g. of a specific type such as user exits only, table accessing operations only, etc., which occur while the selected display screen is being displayed to a user of the input program.

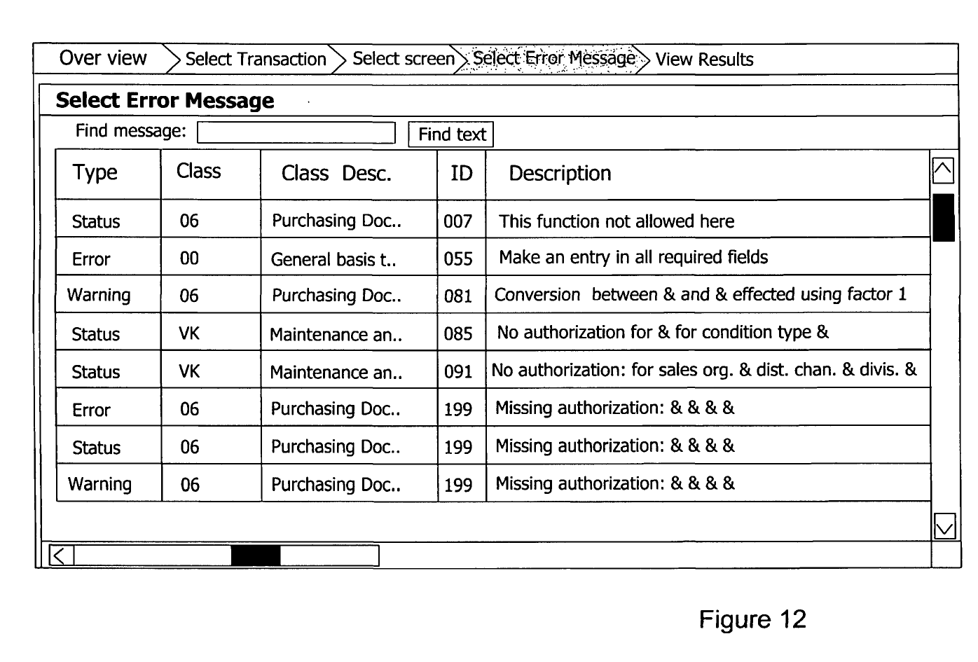

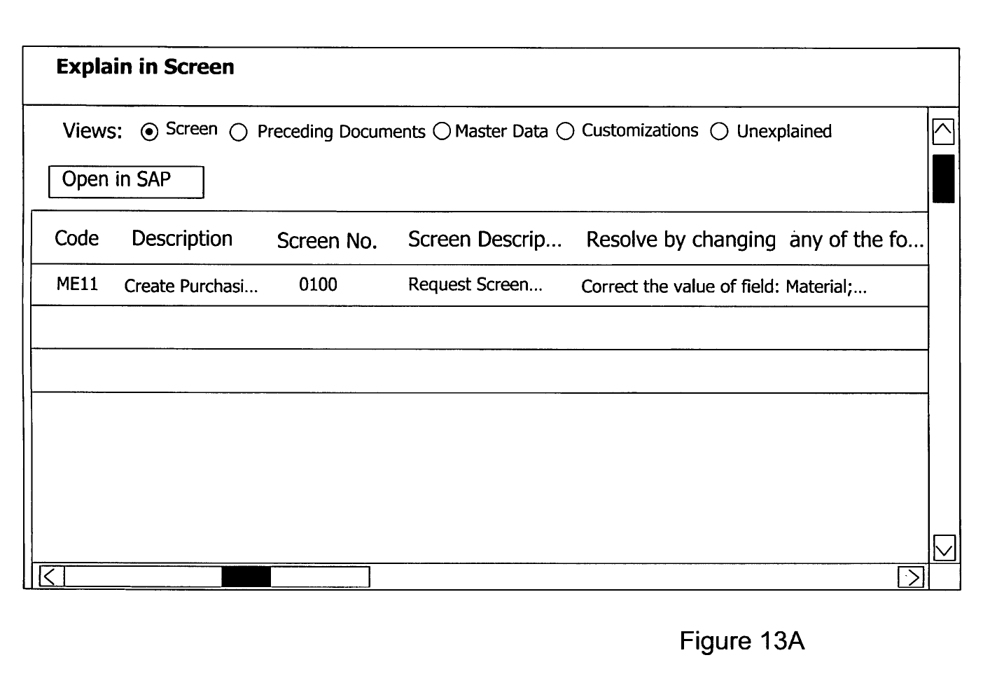

FIGS. 12-14 are simplified pictorial illustrations of computer display screens which together form a suitable user interface facilitating performance of the root cause analysis step of FIG. 1. In particular:

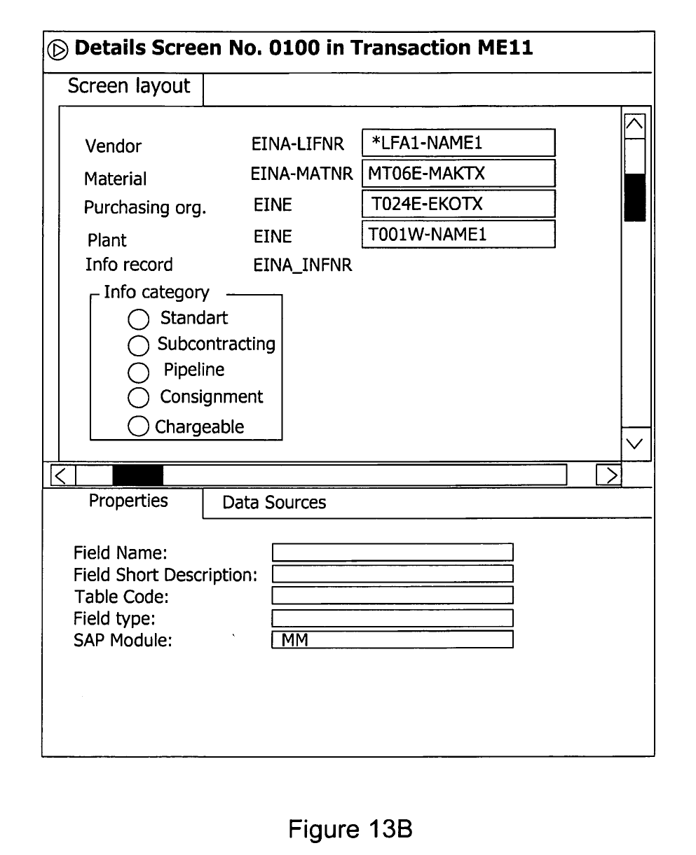

FIG. 12 is a simplified pictorial illustration of an example of a computer display screen enabling a user of the system of FIG. 1 to select an error message to be “solved” i.e. for which a root cause is to be determined by performing the root cause analysis step 110 of FIG. 1. The list of error messages appearing in FIG. 12 typically comprises all error messages within an individual transaction earlier selected by the user (e.g. transaction ME11 in the illustrated example as shown in FIG. 13A), or all error messages associated with an input program display screen earlier selected by the user (such as screen 0100 in the illustrated embodiment as shown in FIG. 13A). An error message is associated with a screen if it occurs while the screen is being displayed.

As explained above, FIG. 13A shows a screen selected by a user within a transaction selected by a user. Each error statement selected in FIG. 12 has one or more possible root causes, identifiable by means of the root cause analysis method of FIG. 3, which, in the case of SAP ERP, are typically each either a screen field defining a statement, a customization statement, a master data statement, or a statement which falls in none of the above categories. A “customization statement” is a select statement that uses a customization-type table. A “master data statement” is a select statement that uses a master-data type table.

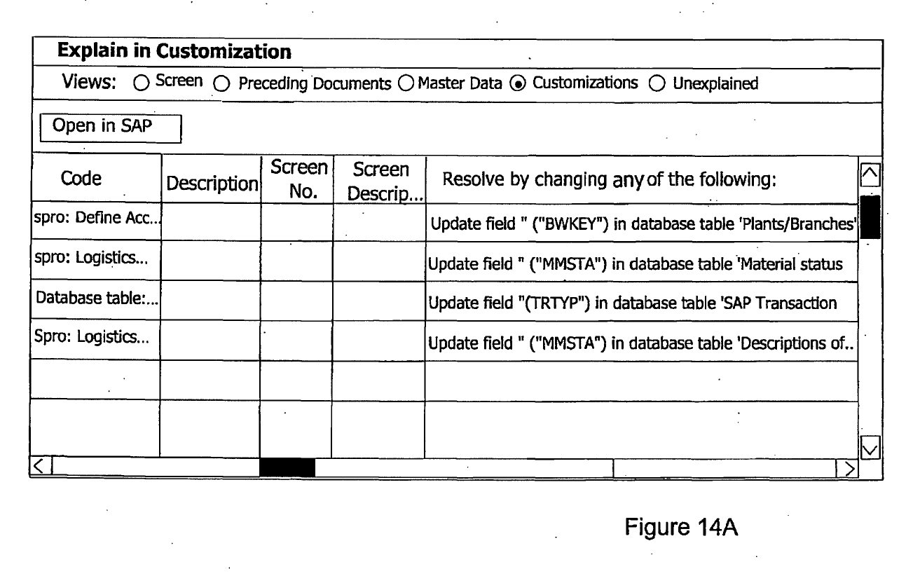

The system of the present invention preferably displays the various categories of possible root causes separately. For example, in FIG. 13A, the user elects to see all screen field defining statements which may be root causes of his selected error message. In the illustrated embodiment, there is only one such screen field defining statement as shown in FIG. 13A. Responsively, the user sees the screen of FIG. 13B. In FIG. 14A, the user selects to see all customization statements which may be root causes of his selected error. In the illustrated embodiment, four such customization statements exist. Selecting one of them, e.g. by clicking, the user is then shown FIG. 14B which shows details of a selected customization statement which is a possible root cause of a selected error message.

It is appreciated that the screen displays of FIGS. 12-14 are particularly suited for implementing the root control analysis method of FIG. 3 in accordance with certain embodiments of the present invention. The display of FIG. 12 may effect the selection of the error message (step 300). The display of FIG. 13A may list screens under which the root cause of the selected error message resides. The display of FIG. 13B may illustrate the layout of a screen selected by the user from among the screens in FIG. 13A. The display of FIG. 14A may list customization tables that are the root cause of the error message selected in step 300. The display of FIG. 14B may provide further detail pertaining to a customization table selected by the user from among the tables of FIG. 14A.

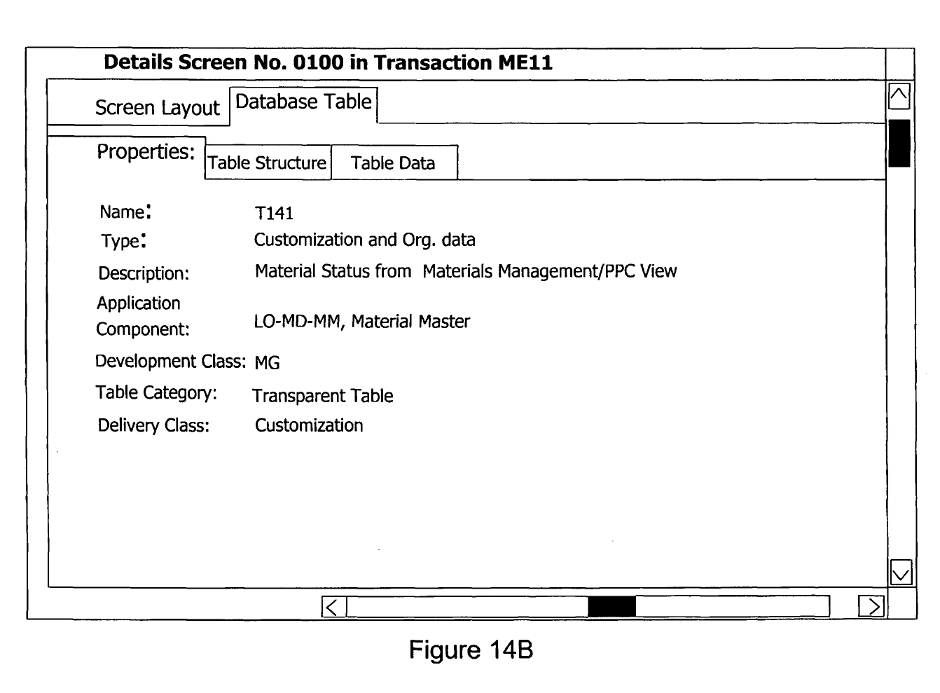

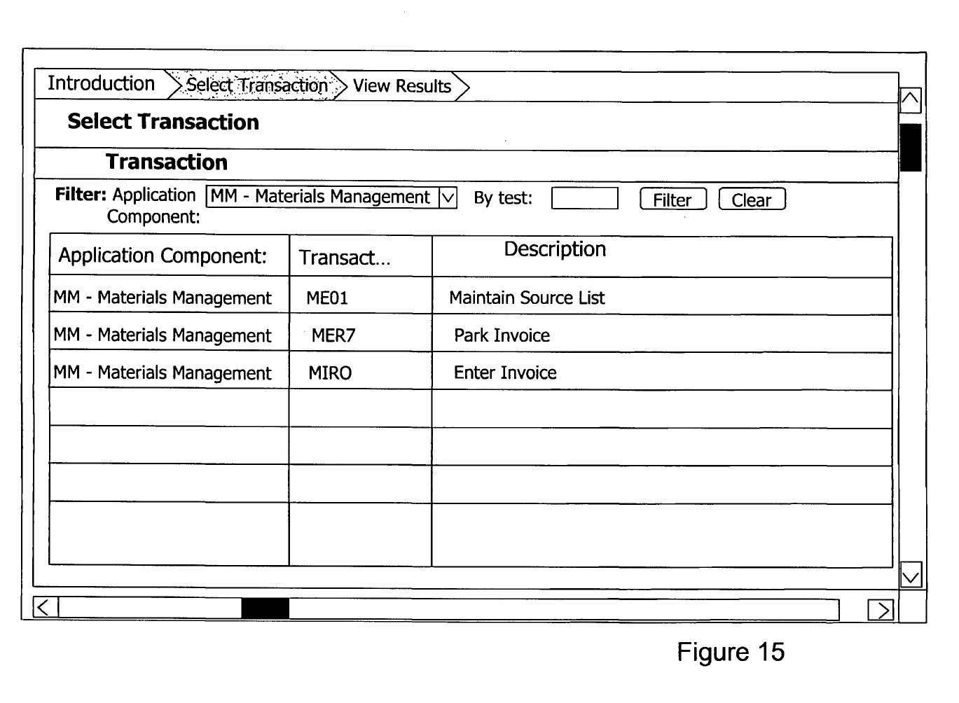

FIGS. 15-17B are simplified pictorial illustrations of computer display screens which together form a suitable user interface facilitating performance of the program investigation step of FIG. 1. In particular:

FIG. 15 is a simplified pictorial illustration of an example of a computer display screen allowing a user of the system of FIG. 1 to select a transaction to be investigated by the program investigation step of FIG. 1, the transaction being user-selected from among a multiplicity of transactions existing within an input program.

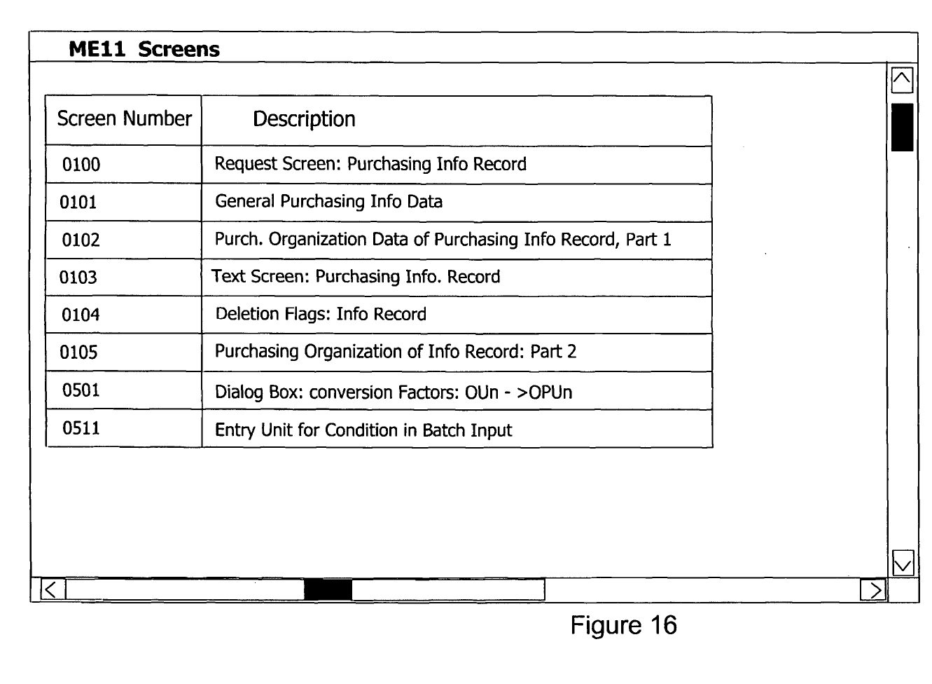

FIG. 16 is a simplified pictorial illustration of an example of a computer display screen showing a user one or more input program screens within the transaction selected in FIG. 15, and allowing the user to select a screen in order to further investigate the content of the selected screen.

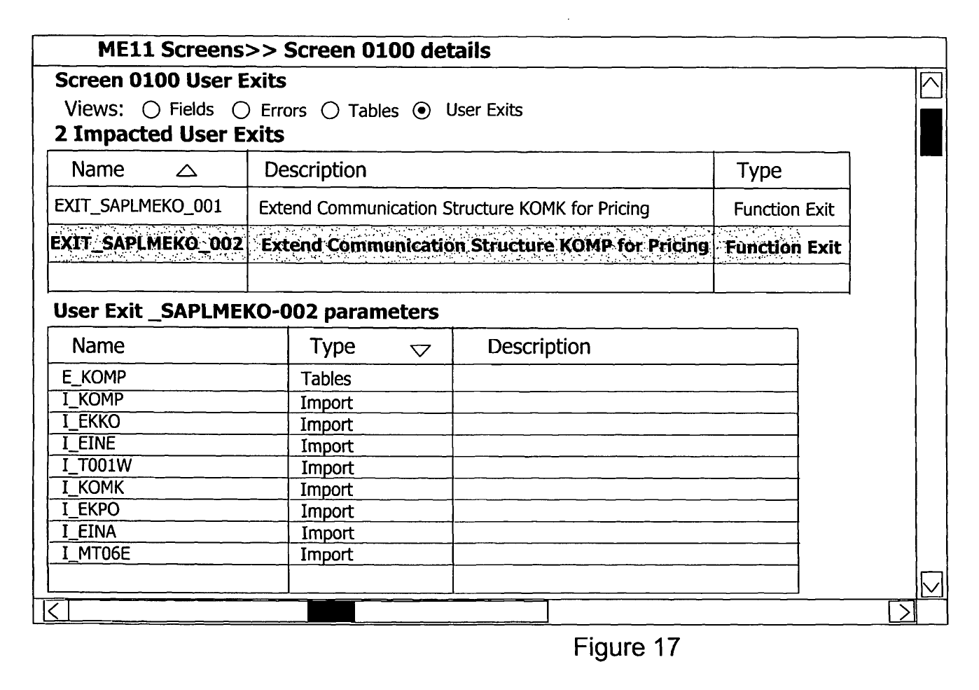

FIG. 17 is a simplified pictorial illustration of an example of a computer display screen listing all user exits which “belong to” the input program screen selected by the user in FIG. 16, i.e. all user exits which occur while the input program screen selected in FIG. 16 is displayed to the user. Similarly, the user may request that any other category of elements associated with a selected input screen be displayed. Particulars of a user-selected user exit may be displayed e.g. using the screen format of FIG. 11B.

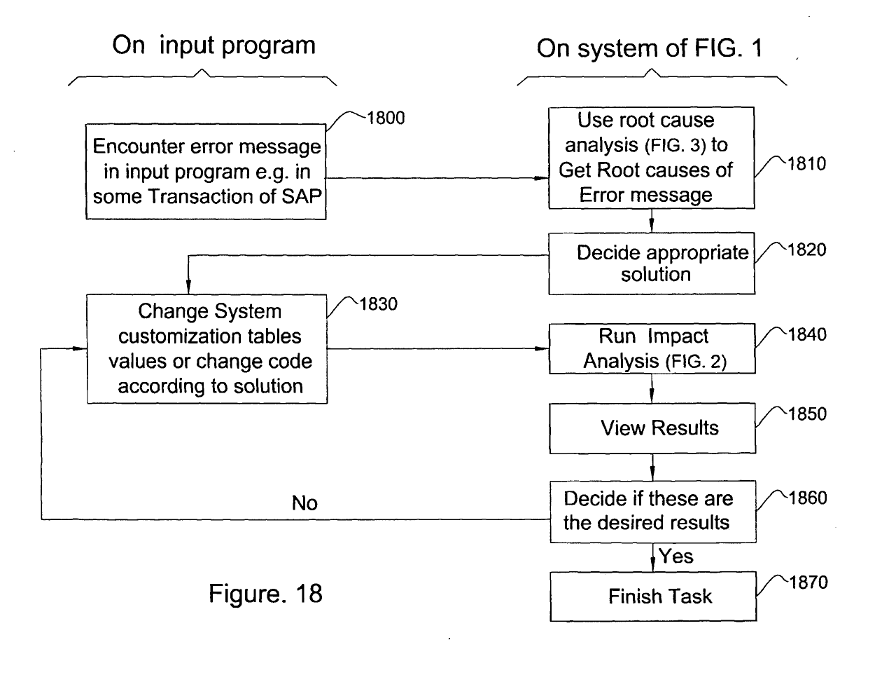

FIG. 18 is a simplified flowchart illustration of a work session using the system of FIGS. 1-4. As shown, if an error message or other problem is encountered while using an input program (step 1800), root cause analysis e.g. as in FIG. 3 may be employed to identify possible root causes of the problem (step 1810). After a solution has been decided upon (step 1820) and implemented (step 1830) or requested within the input program, its impact is tested (step 1840) using impact analysis e.g. as in FIG. 2. The output of the impact analysis is viewed (step 1850) and evaluated (step 1860). If the results are unsatisfactory, return to step 1830.

For example, a SAP ERP end user may encounter a bug (error message) in a screen transaction. He calls support and reports this bug. The bug is directed to a bug solver who uses the system of the present invention.

The system of the present invention may have a home page which allows a user to select either:
a. Online error resolution—which yields probable causes for a given error message and suggestions for its resolution, preferably using the root control analysis method of FIG. 3.
b. Customization impact discovery in which, e.g. for SAP, a customization change request's impact is discovered on the standard 4.6C SAP edition without having been transported, preferably using the impact analysis method of FIG. 2.
c. Transaction field investigation—discovers tables from which values are imported to or exported from a field, preferably using the program investigation method of FIG. 4.
d. User exit finding—allows user to find user exits in a transaction, preferably using the program investigation method of FIG. 4.

The root cause analysis module 110 of FIG. 1 preferably identifies one, some or all of the following three types of solutions for the bug that has been found:
a. RCA module 110 highlights fields within the screen just preceding the bug, which, if their value is changed, might resolve the bug;
b. RCA module 110 highlights fields within screens in other SAP ERP transactions which might, if their value is changed, resolve the bug;
c. RCA module 110 suggests parameters stored in specific tables, such as master data tables or customization tables, which, if changed, may resolve the bug.

To obtain the above information, the bug solver typically first specifies the transaction in which the bug e.g. error message, appeared, then specifies the screen within the transaction in which the bug appeared, then selects the error message as described above with reference to FIG. 12, then views results of root cause analysis on the bug as described above with reference to FIGS. 13A-13B.

If, in step 1830, the bug solver elects to change values of the input program's customization parameters (as opposed to or in addition to changing the code of the input program), the bug solver preferably runs the impact analysis functionality 100 of FIG. 1. This allows the bug solver to see the impact of the change he is contemplating, on the input system, in terms of the important elements defined for the impact analysis functionality. For example, for SAP ERP, the bug solver might see the impact in terms of user transactions, screens, fields, errors and user-exits. To obtain this information, the bug solver first selects “his” change request, then specifies the transactions that are of interest to him. Preferably, estimated processing time is displayed, enabling the bug solver to modify the list of transactions of interest accordingly. The impact analysis then runs and the user can view its results which typically include a list of impacted transactions each of which open, upon being selected by the bug solver, to show a list of impacted screens within the selected transaction. For each screen, as described above with reference to FIGS. 5-11, information is provided re impacted elements such as impacted screen fields, errors, tables and user exits.

If the input program is SAP, once the user is satisfied with the results of the impact analysis, he can finish the task and move his change request into the SAP QA system and the SAP production system.

A particular advantage of certain embodiments of the present invention is in the facilitation provided any end user, including an end user having no programming ability, to configure a computer program s/he is using. The embodiment shown and described herein typically provides the end user with an output which documents, displays or otherwise represents all end-results, or all important end-results, of a sequence of one or more configuration changes. The advantages of such an output are clear since a given computer program may have millions of possible configurations each of which, when effected, typically causes many end results.

It is appreciated that the definitions determining importance and ranking of displayed results need not be uniform over all users and instead may be customized to individual application and/or to individual user profiles.

According to certain embodiments of the present invention, a software system analysis system is provided which comprises a static analyzer operative to analyze a computer program. The computer program is written in a programming language defining a set of syntactical elements. The computer program has a user interface defining a set of user-interface elements. The software system analysis system is preferably operative to identify at least one syntactical element which is associated with an impact which relates to a user. This syntactical element may for example be: (a) an impacting syntactical element which generates an impact relevant to the user; or (b) an impacted syntactical element which is affected by an impact relevant to the user.

Also provided is a user-comprehensible display displaying the impact-associated syntactical elements in association with a relevant member of the set of user-interface elements. Preferably, the user-comprehensible display displays each impact-associated syntactical element responsive to a user's selection of a user-interface element which occurs just prior to occurrence of the impact. For example, each result of a given impact analysis query may be displayed responsive to a user's selection of the screen (user interface element) which occurs just prior to occurrence of that particular IA query response.

Any suitable method may be employed to associate a response returned to a query, with a user interface component so as to display the query response in a manner which is easily comprehensible to the user of the computer program. For example, if the query is an impact analysis-type query, the following association rules may be employed:
(a) For a select statement, that is the origin of the slicing, associate the statement with the screen from which that statement has been collected.
(b) Call screen statements are associated with the screen that they call.
(c) For all other statements s1, if s1 was reached in the control flow graph 156, by traversing an edge (s2,s1), pick the screen that is associated with s2 and associate s1 with that screen.

The invention shown and described herein is applicable to a broad variety of input programs including but not limited to ERP (Enterprise Resource Planning), billing, CRM (Customer Relationship Management), OS (Operating System) administration, any packaged application, and any home grown software system.

According to one embodiment of the invention, the system may comprise one or more computers or other programmable devices, programmed in accordance with some or all of the apparatus, methods, features and functionalities shown and described herein. Alternatively or in addition, the apparatus of the present invention may comprise a memory which is readable by a machine and which contains, stores or otherwise embodies a program of instructions which, when executed by the machine, comprises an implementation of some or all of the apparatus, methods, features and functionalities shown and described herein. Alternatively or in addition, the apparatus of the present invention may comprise a computer program implementing some or all of the apparatus, methods, features and functionalities shown and described herein and being readable by a computer for performing some or all of the methods of, and/or implementing some or all of the systems of, embodiments of the invention as described herein.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Features of the present invention which are described in the context of separate embodiments may also be provided in combination in a single embodiment. Conversely, features of the invention which are described for brevity in the context of a single embodiment may be provided separately or in any suitable subcombination.

1. A method for analyzing a computer program comprising a first multiplicity of elements having a second multiplicity of functional relationships defined therebetween, the first multiplicity of elements including interface elements and non-interface elements, the method comprising:
Reading source code;
Isolating at least selected ones of said interface elements from the source code;
Identifying, and displaying to a user, only those functional relationships which are defined between said isolated interface elements, wherein customer-specific information is used to perform said identifying.

2. A method for analyzing a computer program comprising a multiplicity of computer program elements including impacting elements and impacted elements, wherein said impacting elements impact upon said impacted elements, the method comprising:
identifying a plurality of impacts between at least one impacting element and at least one impacted element;
prioritizing said plurality of impacts; and
displaying at least some of said plurality of impacts in relation to the computer program's behavior rather than in relation to the computer program's structure, so as to prioritize highly prioritized impacts.

3. A method according to claim 1 and also comprising using said customer-specific information to make an a priori identification of interface elements between which no functional relationship exists.

4. A method according to claim 1 and also comprising using said customer-specific information to eliminate impossible functional relationships given said customer-specific information.

5. A method according to claim 2 wherein said identifying comprises impact analysis identifying impacts occurring between a user-selected impacting element and elements impacted thereby.

6. A method according to claim 2 wherein said identifying comprises root cause analysis identifying impacts occurring between a user-selected impacted element and elements impacting it.

7. A method according to claim 2 wherein said prioritizing of impacts comprises ranking of elements participating in impacts identified in said identifying.

8. A method according to claim 1 wherein said isolating comprises isolating at least a portion of the impacting interface elements and wherein said impacting interface elements comprise at least one of the following types of impacting interface elements:
Customization data; and
Code changes.

9. A method according to claim 1 wherein said identifying comprises performing root cause analysis by identifying at least one impacting interface element having a functional relationship with a user-selected impacted interface element.

10. A method according to claim 2 wherein said prioritizing comprises selection of a subset of impacts which are deemed important and displaying only said subset of impacts.

11. A method according to claim 1 wherein said identifying comprises performing impact analysis by identifying at least one impacted interface element having a functional relationship with a user-selected impacting interface element.

12. A method according to claim 1 wherein said computer program comprises a collection of statements written in a computer language and wherein each element comprises at least one computer language statement.

13. A method according to claim 1 wherein said isolating comprises isolating at least a portion of the impacting interface elements and wherein said impacting interface elements comprise at least one of the following types of impacted interface elements:
at least one field in a display screen;
at least one error message;
a read-type interaction with a database;
a write-type interaction with a database;
a call to an external function.

14. A system for analyzing a computer program comprising a first multiplicity of elements having a second multiplicity of functional relationships defined therebetween, the first multiplicity of elements including interface elements and non-interface elements, the apparatus comprising:
A source code analyzer operative to isolate at least selected ones of said interface elements from the source code; and,
A functional relationship display unit operative to identify only those functional relationships which are defined between said isolated interface elements,
wherein customer-specific information is used to identify said functional relationships.

15. A method according to claim 1 wherein said isolating comprises isolating at least one interface element pertaining to a user-selected program and wherein said identifying comprises performing program investigation by identifying only those functional relationships defined between said isolated interface elements pertaining to said user-selected program.

16. A method according to claim 15 wherein said user-selected program comprises a user-selected transaction and said at least one interface element pertaining to a user-selected program comprises all interface elements pertaining to the user-selected transaction.

17. A system according to claim 14 and wherein said analyzer is operative to isolate at least a portion of the impacting interface elements.

18. A system according to claim 14 wherein said analyzer is operative to isolate at least a portion of the impacted interface elements.

19. A system according to claim 14 wherein said display unit is operative to perform root cause analysis by identifying at least one impacting interface element having a functional relationship with a user-selected impacted interface element.

20. A system according to claim 14 wherein said display unit is operative to perform impact analysis by identifying at least one impacted interface element having a functional relationship with a user-selected impacting interface element.

21. A software system analysis system comprising:
A static analyzer operative to analyze a computer program, written in a programming language defining a set of syntactical elements and having a user interface defining a set of user-interface elements having members, including identifying at least one of said syntactical elements which is associated with an impact which relates to a user; and
A user-comprehensible display displaying at least said impact-associated syntactical element in association with a relevant member of said set of user-interface elements.

22. A system according to claim 21 wherein said at least one syntactical element associated with an impact which relates to a user comprises an impacting syntactical element which generates an impact relevant to the user.

23. A system according to claim 21 wherein said at least one syntactical element associated with an impact which relates to a user comprises an impacted syntactical element which is affected by an impact relevant to the user.

24. A method according to claim 1 and also comprising using customer-specific information to perform said identifying including:
using said customer-specific information to make an a-priori identification of interface elements between which no functional relationship exists; and
using said customer-specific information to eliminate impossible functional relationships given said customer-specific information,
wherein said isolating comprises:
isolating at least a portion of the impacting interface elements; and
isolating at least a portion of the impacted interface elements.

25. A system for analyzing a computer program comprising a multiplicity of computer program elements including impacting elements and impacted elements, wherein said impacting elements impact upon said impacted elements, the system comprising:
an impact identifier operative to identify a plurality of impacts between at least one impacting element and at least one impacted element; and
an impact display generator operative to prioritize said plurality of impacts and to generate a representation, for display, of at least some of said plurality of impacts in relation to the computer program's behavior rather than in relation to the computer program's structure, wherein said representation prioritizes highly prioritized impacts.
